(19) United States
(12) Patent Application Publication
(10) Pub. No.: US 2025/0347311 A1
(43) Pub. Date: Nov. 13, 2025

(54) FASTENING DEVICE FOR FASTENING A VEHICLE WHEEL RIM TO A WHEEL HUB

(71) Applicant: GOURMET EQUIPMENT (TAIWAN) CORPORATION, Taipei City (TW)

(72) Inventor: Peter J.H. Chang, Taipei City (TW)

(73) Assignee: GOURMET EQUIPMENT (TAIWAN) CORPORATION, Taipei City (TW)

(21) Appl. No.: 18/749,334

(22) Filed: Jun. 20, 2024

(30) Foreign Application Priority Data
May 8, 2024 (TW) 113204635

(51) Int. Cl. F16B 39/28; B60B 3/16; F16B 39/01

(52) U.S. Cl. CPC F16B 39/28; B60B 3/16; F16B 39/01

(57) ABSTRACT

A fastening device is disposed in one installation hole of a vehicle wheel rim to fasten the wheel rim to a wheel hub. The fastening device includes a fastening unit and a reinforcing unit. The fastening unit has an abutting portion corresponding to the installation hole and a tightening portion coaxially connected with the abutting portion. The reinforcing unit is coaxially and rotatably coupled with the fastening unit, and has a friction wall which extends radially to abut against an abutting wall of the fastening unit. The reinforcing unit is rotated and tightened along a longitudinal axis to the fastening unit through abutment of the friction wall against the abutting wall. The fastening unit and the reinforcing unit respectively have first and second threaded holes aligned with each other.

### CROSS-REFERENCE TO RELATED APPLICATION

This application claims priority to Taiwanese Patent Application No. 113204635, filed on May 8, 2024, and incorporated by reference herein in its entirety.

### FIELD

The disclosure relates to a fastening device, and more particularly to a fastening device for fastening a vehicle wheel rim to a wheel hub.

### BACKGROUND

Fastening elements employed for fastening a vehicle wheel rim to a wheel hub are known in the art. One kind of wheel hub is provided with bolts fastening elements such as nuts to be engaged therewith, and another kind of wheel hub is provided with threaded holes for fastening elements such as threaded shaft to be engaged therewith.

With the conventional fastening elements, the wheel rim is fastened tightly to the wheel hub when the vehicle is unmoved. However, fastening elements such as the threaded shafts or bolts on the wheel hub might be broken when the vehicle wheel encounters unexpected forces. Specifically, when temperature variation, vehicle vibration, sudden vehicle forwarding or braking occurs, not only will the bolts or the fastening elements be damaged, but the fastening elements will also easily loosen or fall off from the wheel. Moreover, for electrical vehicles, the instantaneous torque is large when starting the vehicle and the power output is transmission quickly to the wheels such that the fastening elements might loosen, which will damage the vehicle and cause considerable danger to the driver.

### SUMMARY

Therefore, an object of the disclosure is to provide a fastening device that can alleviate at least one of the drawbacks of the prior art.

According to the disclosure, the fastening device is adapted for fastening a vehicle wheel rim to a wheel hub. The vehicle wheel rim has a plurality of hole-defining walls each defining an installation hole therein. The fastening device is disposed in one of the installation holes, and includes a fastening unit and a reinforcing unit. The fastening unit extends along a longitudinal axis, and has an abutting portion which corresponds in shape to the installation hole to be engaged with the corresponding hole-defining wall, a tightening portion which is coaxially connected with the abutting portion, an abutting wall which extends radially from one of the abutting portion and the tightening portion, and a first threaded hole which is formed in the abutting portion and which extends along the longitudinal axis. The first threaded hole has first threads. The reinforcing unit is coaxially coupled with the fastening unit, and is rotatable relative to the fastening unit about the longitudinal axis. The reinforcing unit has a friction wall which extends radially to face the abutting wall, and a second threaded hole which extends along the longitudinal axis to be aligned with the first threaded hole. The reinforcing unit is rotated and tightened along the longitudinal axis to the fastening unit through abutment of the friction wall against the abutting wall.

With the frictional abutment of the friction wall against the abutting wall, the reinforcing unit and the fastening unit are pressed and abutted against each other. Also, as the reinforcing unit is rotatable about the longitudinal axis of the fastening unit and has second threads, the fastening device can be tightened more firmly to the wheel rim in a fastening condition when the fastening device is mounted in the installation hole. Thus, even when temperature variation, vehicle vibration, sudden vehicle forwarding or braking occurs, the fastening device is firmly fastening the wheel rim to the wheel hub.

### BRIEF DESCRIPTION OF THE DRAWINGS

Other features and advantages of the disclosure will become apparent in the following detailed description of the embodiments with reference to the accompanying drawings. It is noted that various features may not be drawn to scale.

FIG. 1 is a perspective view illustrating a first embodiment of a fastening device according to the disclosure for fastening a vehicle wheel rim to a wheel hub.

FIG. 2 is a perspective view of the first embodiment.

FIG. 3 is a sectional view taken along line III-III of FIG. 2.

FIG. 4 is an exploded sectional view of the first embodiment.

FIG. 5 is a perspective view of a second embodiment of the fastening device according to the disclosure.

FIG. 6 is a sectional view taken along line VI-VI of FIG. 5.

FIG. 7 is a perspective view of a third embodiment of the fastening device according to the disclosure.

FIG. 8 is a sectional view taken along line VIII-VIII of FIG. 7.

FIG. 9 is a perspective view of a fourth embodiment of the fastening device according to the disclosure.

FIG. 10 is a sectional view taken along line X-X of FIG. 9.

FIG. 11 is an exploded sectional view of an embodiment of the fastening device in a modified form.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

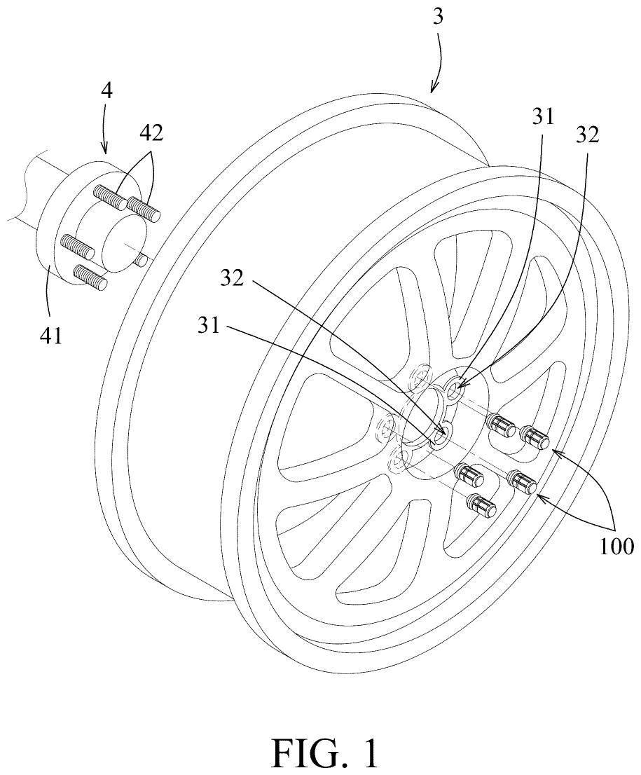

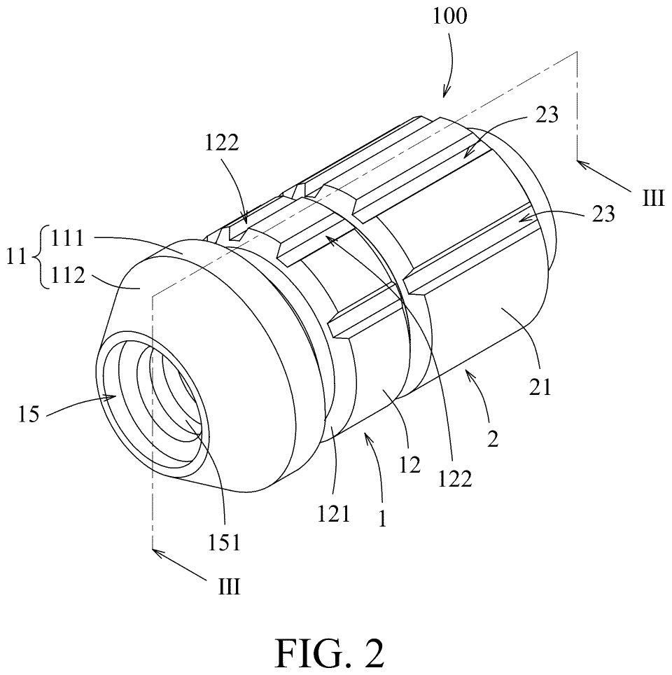

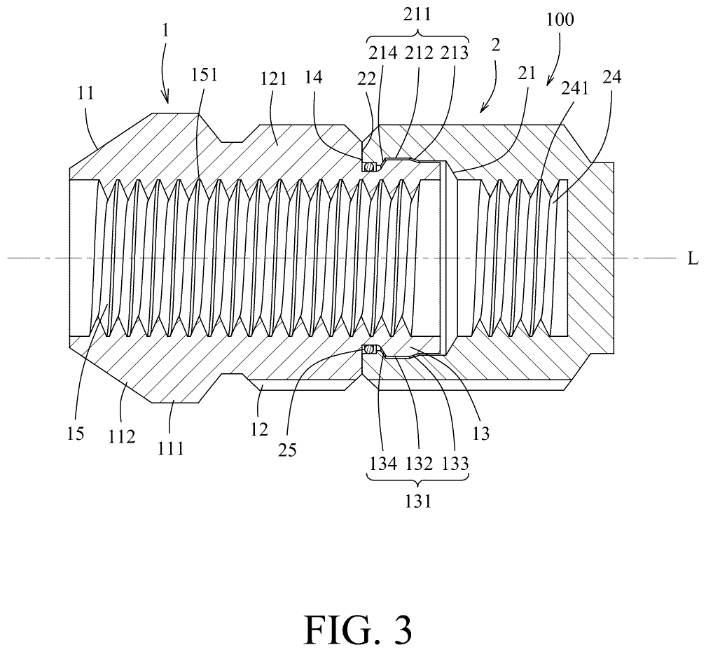

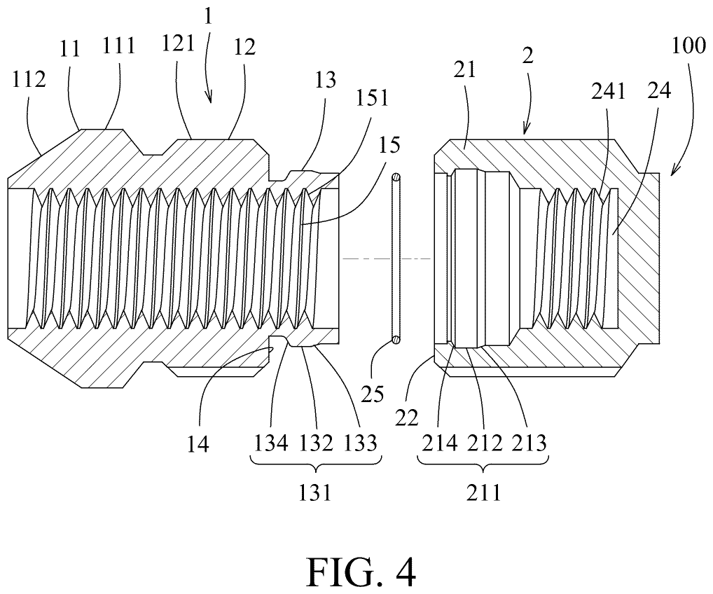

Referring to FIGS. 1 to 4, a first embodiment of a fastening device 100 according to the disclosure is adapted for fastening a vehicle wheel rim 3 to a wheel hub 4. The vehicle wheel rim 3 has a plurality of hole-defining walls 31 each defining an installation hole 32 therein. The wheel hub 4 has a hub body 41 and a plurality of threadedly engaging sections 42 in the form of bolts and extending from the hub body 41 to respectively correspond with the installation holes 32. In FIG. 1, a plurality of fastening devices 100 respectively extend through the installation holes 32 and are respectively and threadedly engaged with the threadedly engaging sections 42 so as to fasten the wheel rim 3 to the wheel hub 4. Each fastening device 100 includes a fastening unit 1 and a reinforcing unit 2.

The fastening unit 1 is in the form of a nut, and extends along a longitudinal axis (L). The fastening unit 1 includes an abutting portion 11, a tightening portion 12, an extending portion 13 and an abutting wall 14. The abutting portion 11 corresponds in shape to the installation hole 32 to be engaged with the corresponding hole-defining wall 31, and includes a surrounding section 111 which has an outer diameter larger than an outer diameter of the tightening portion 12, and a taper section 112 which extends from the surrounding section 111 along the longitudinal axis (L) and which is tapered away from the surrounding section 111 to have a frusto-conical cross-section. The tightening portion 12 is coaxially connected with the abutting portion 11 and the extending portion 13, and includes a cylindrical wall 121 extending along the longitudinal axis (L) to terminate at an end which is connected with the abutting portion 11, and an opposite end which is connected with the abutting wall 14 and the extending portion 13. A plurality of first spline grooves 122 are formed in the outer surface of the cylindrical wall 121 and extend along the longitudinal axis (L). The abutting wall 14 extends radially and inwardly from the tightening portion 12. The extending portion 13 is coaxially connected with the tightening portion 12 and extends along the longitudinal axis (L) away from the abutting portion 11. The extending portion 13 has an outer diameter smaller than those of the abutting portion 11 and the tightening portion 12. The extending portion 13 has an outer engaging section 131. The outer engaging section 131 has a protuberance 132 which extends along the longitudinal axis (L) to terminate at two ends proximal to and distal from the abutting wall 14, respectively, a first end flange 133 which is connected with and is inclined relative to the end of the protuberance 132 distal from the abutting wall 14, and a second end flange 134 which is connected with and is inclined relative to the end of the protuberance 132 proximal to the abutting wall 14. A first threaded hole 15 is formed in and extends through the abutting portion 11, the tightening portion 12 and the extending portion 13 along the longitudinal axis (L), and has first threads 151 corresponding to the threadedly engaging section 42 of the wheel hub 4.

The reinforcing unit 2 is coaxially coupled with the fastening unit 1, and is rotatable relative to the fastening unit 1 about the longitudinal axis (L). The reinforcing unit 2 has a sleeve portion 21 which surrounds the longitudinal axis (L) to sleeve around the extending portion 13 and part of the threadedly engaging section 42 and which extends along the longitudinal axis (L) to terminate at a friction wall 22. The friction wall 22 extends radially and inwardly toward the longitudinal axis (L) to face the abutting wall 14. The sleeve portion 21 has an inner engaging section 211 which has an inner diameter slightly larger than an outer diameter of the outer engaging section 131. The inner engaging section 211 is engaged with the outer engaging section 131 to retain the extending portion 13 to the sleeve portion 21. Specifically, the inner engaging section 211 has an annular groove 212 for accommodating the protuberance 132 therein. The annular groove 212 extends along the longitudinal axis (L) to terminate at two ends proximal to and distal from the friction wall 22, respectively. The inner engaging section 211 further has a first slope surface 213 which is connected with and is inclined relative to the end of the annular groove 212 distal from the friction wall 22 and which is retainingly engaged with the first end flange 133, and a second slope surface 214 which is connected with and is inclined relative to the end of the annular groove 212 proximal to the friction wall 22 and which is retainingly engaged with the second end flange 134. Thus, the protuberance 132 is received in and rotatable relative to the annular groove 212. The reinforcing unit 2 is rotated and tightened along the longitudinal axis (L) to the fastening unit 1 through abutment of the friction wall 22 against the abutting wall 14. The reinforcing unit 2 has a plurality of second spline grooves 23 formed in the outer surface of the sleeve portion 21 and extending along the longitudinal axis (L), and a second threaded hole 24 formed in the sleeve portion 21 and extending along the longitudinal axis (L) to be aligned with the first threaded hole 15. The second threaded hole 24 has second threads 241. The threadedly engaging section 42 of the wheel hub 4 is insertable into the first and second threaded holes 15, 24 and is threadedly engaged with the first and second threads 151, 241 so as to fasten the wheel rim 3 to the wheel hub 4 through the fastening device 100. The reinforcing unit 2 further has an elastic ring 25, such as an O-ring, which is sleeved on the sleeve portion 21 adjacent to the second slope surface 214 to seal a clearance between the sleeve portion 21 and the extending portion 13.

In use, the first threaded hole 15 and the second threaded hole 24 are registered with the threadedly engaging section 42, and the fastening unit 1 and the reinforcing unit 2 are operatively rotated to threadedly engage with the threadedly engaging section 42 with a first predetermined tightening torque (for example, a standard tightening torque for vehicle wheels). Then, only the reinforcing unit 2 is rotated and tightened toward the fastening unit 1 with a second predetermined tightening torque (for example, a tightening torque slightly larger than the first predetermined tightening torque) to reinforce the tightening force to the threadedly engaging section 42. As compared with the integrally formed fastening element of the prior art, with the reinforcing unit 2 of the fastening device 100 according to the disclosure, a larger tightening force is applied to the threadedly engaging section 42, and a shock-absorbing and frictional action is provided to avoid breaking of the threadedly engaging section 42. The second threads 241 of the reinforcing unit 2 is further engaged with the threadedly engaging section 42 to avoid removal of the wheel rim 3 from the wheel hub 4 when the instantaneous torque of the vehicle is large during the starting of the vehicle.

It is to be mentioned that the fastening unit 1 and the reinforcing unit 2 may be coupled with each other during manufacturing of the fastening device 100, or made separately. In other words, the fastening unit 1 and the reinforcing unit 2 may be coupled with each other as a product available for purchase, or may be purchased separately.

Moreover, surface treatment can be separately applied to the fastening unit 1 and the reinforcing unit 2. For example, the fastening unit 1 may be coated with zinc so as to tightly abut against the wheel rim 3 and prevent slipping relative to the wheel rim 3 and maintain the tightening torque to thereby reduce the risk of detachment of the wheel rim 3 from the wheel hub 4. The reinforcing unit 2 may be coated with chromium to enhance the corrosion resistance and enhance aesthetical appearance. Furthermore, the fastening unit 1 and the reinforcing unit 2 may be made of any material according to practical requirements.

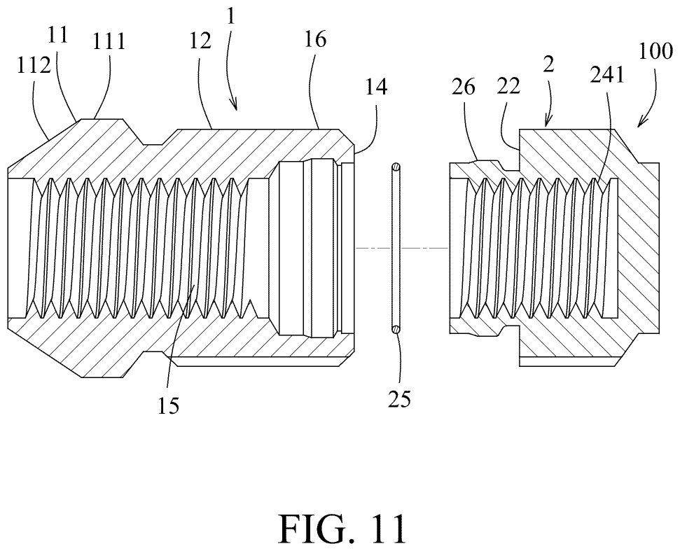

With reference to FIG. 11, in a modified form of the first embodiment, the fastening unit 1 includes a sleeve portion 16, and the reinforcing unit 2 includes an extending portion 26. Specifically, the sleeve portion 16 is connected with the tightening portion 12 and extends along the longitudinal axis (L) to terminate at the abutting wall 14. The extending portion 26 is connected with the friction wall 22 and extends along the longitudinal axis (L) to be inserted into the sleeve portion 16.

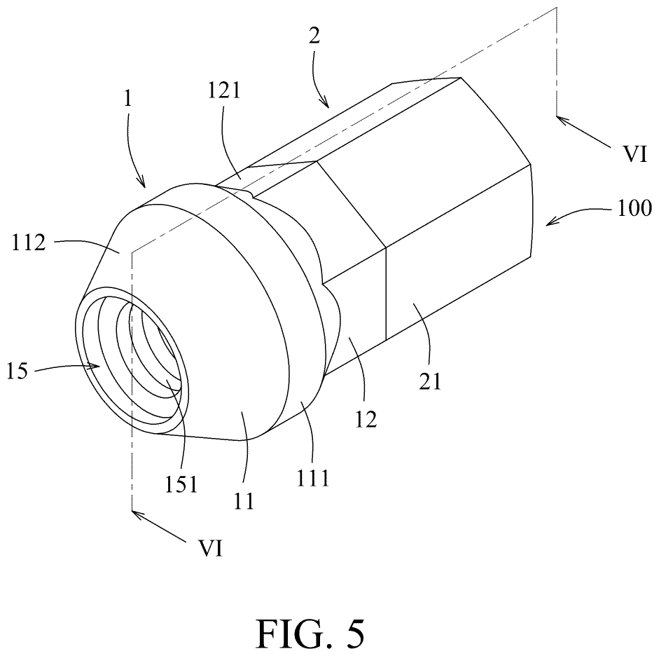

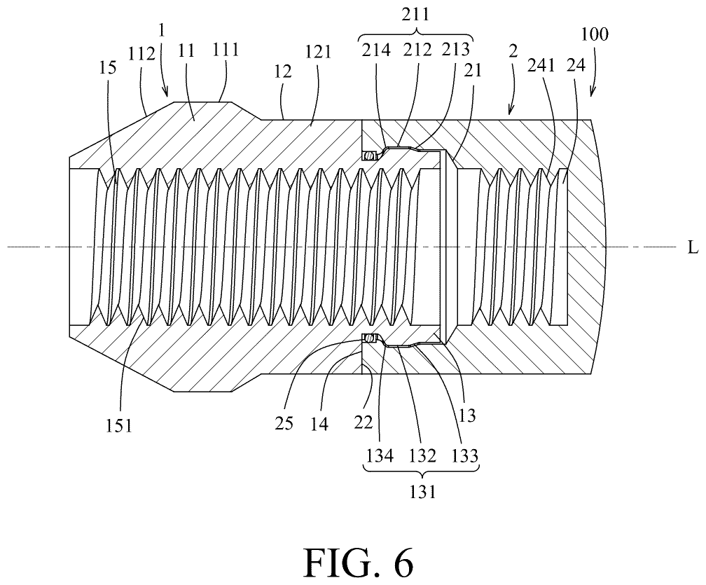

With reference to FIGS. 5 and 6, in a second embodiment of the fastening device 100, the fastening unit 1 and the reinforcing unit 2 have a flat outer surface free of the first and second spline grooves 122, 23.

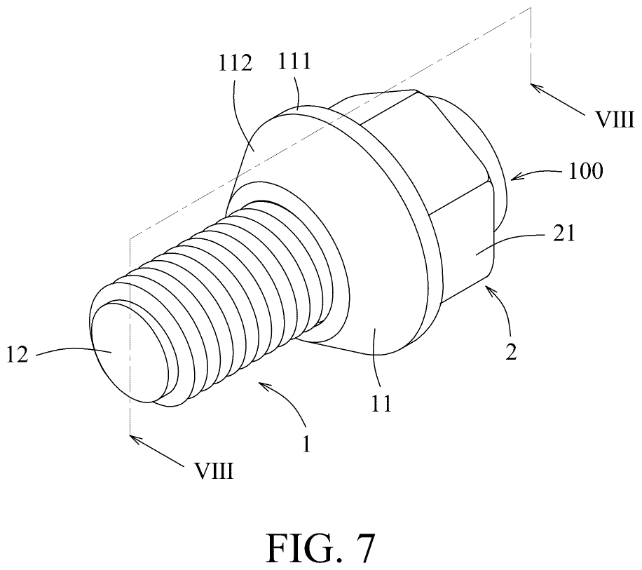

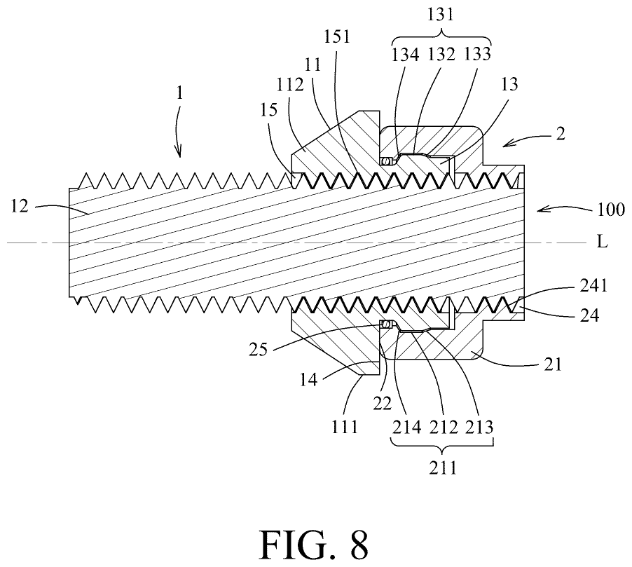

With reference to FIGS. 7 and 8, in a third embodiment of the fastening device 100, the fastening unit 1 is in the form of a bolt, and the extending portion 13 extends from and is connected with the abutting portion 11. The first threaded hole 15 extends through the abutting portion 11 and the extending portion 13, and the tightening portion 12 is a threaded shaft which is threadedly engaged with the first threaded hole 15 and the second threaded hole 24. In this embodiment, the threadedly engaging section 42 corresponding with the fastening device 100 is in the form of a threaded hole such that a portion of the tightening portion 12 projecting from the abutting portion 11 is threadedly engaged in the threadedly engaging section 42 to fasten the wheel rim 3 to the wheel hub 4 through the fastening device 100.

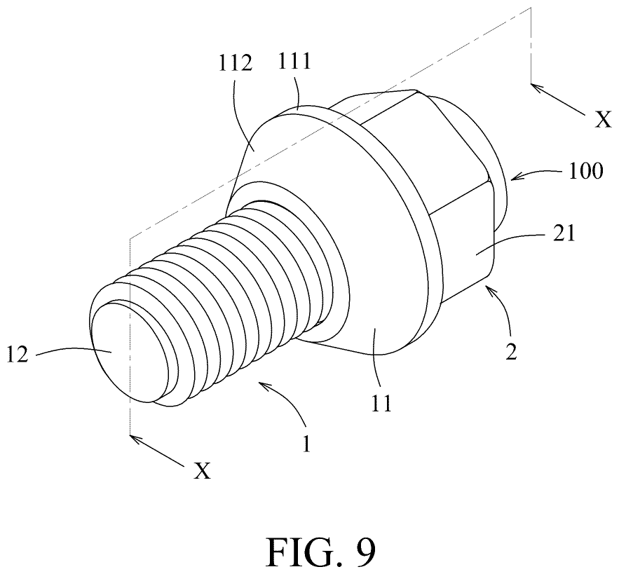

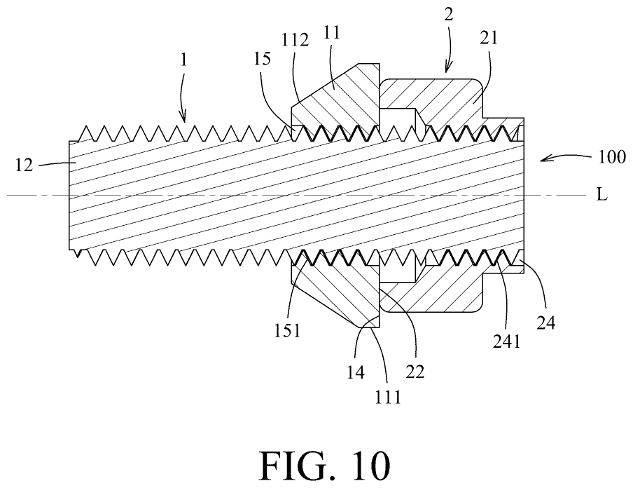

With reference to FIGS. 9 and 10, in a fourth embodiment of the fastening device 100, a difference from the above first embodiment resides in that an extending portion 13 of the fastening unit 1 and the inner engaging section 211 of the sleeve portion 21 of the reinforcing unit 2 are dispensed with. Through the frictional abutment of the friction wall 22 against the abutting wall 14, and the threaded engagement of the tightening portion 12 in the first and second threaded holes 15, 24, the reinforcing unit 2 is tightened to the fastening unit 1 and the weight of the fastening device 100 is reduced.

It should be mentioned that the dimension and structure of the fastening device 100 may be adjusted according to practical requirements, and may be designed to allow specific hand tools to be thiefproof.

As illustrated, with the frictional abutment of the friction wall 22 against the abutting wall 14, the reinforcing unit 2 and the fastening unit 1 are pressed and abutted against each other. Also, as the reinforcing unit 2 is rotatable about the longitudinal axis (L) of the fastening unit 1 and has second threads 241, the fastening device 100 can be tightened more firmly to the wheel rim 3 in a fastening condition when the fastening device 100 is mounted in the installation hole 32. Thus, even when temperature variation, vehicle vibration, sudden vehicle forwarding or braking occurs, the fastening device 100 firmly fastens the wheel rim 3 to the wheel hub 4.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A fastening device for fastening a vehicle wheel rim to a wheel hub, the vehicle wheel rim having a plurality of hole-defining walls each defining an installation hole therein, said fastening device being disposed in one of the installation holes, and comprising:
a fastening unit extending along a longitudinal axis, and having an abutting portion which corresponds in shape to the installation hole to be engaged with the corresponding hole-defining wall, a tightening portion which is coaxially connected with said abutting portion, an abutting wall which extends radially from one of said abutting portion and said tightening portion, and a first threaded hole which is formed in said abutting portion and which extends along the longitudinal axis, said first threaded hole having first threads; and
an reinforcing unit coaxially coupled with said fastening unit, and rotatable relative to said fastening unit about the longitudinal axis, said reinforcing unit having a friction wall which extends radially to face said abutting wall, and a second threaded hole which extends along the longitudinal axis to be aligned with said first threaded hole, wherein said reinforcing unit is rotated and tightened along the longitudinal axis to said fastening unit through abutment of said friction wall against said abutting wall.

2. The fastening device of claim 1, wherein said abutting portion includes a surrounding section which has an outer diameter larger than an outer diameter of said tightening portion, and a taper section which extends from said surrounding section along the longitudinal axis and which is tapered away from said surrounding section to have a frusto-conical cross-section.

3. The fastening device of claim 1, wherein said fastening unit further has an extending portion which is coaxially connected with said tightening portion and which extends along the longitudinal axis away from said abutting portion, said reinforcing unit further having a sleeve portion which surrounds the longitudinal axis to sleeve around said extending portion and which extends along the longitudinal axis to terminate at said friction wall.

4. The fastening device of claim 3, wherein said extending portion has an outer engaging section, said sleeve portion having an inner engaging section which is engaged with said outer engaging section to retain said extending portion to said sleeve portion.

5. The fastening device of claim 4, wherein said outer engaging section has a protuberance, said inner engaging section having an annular groove for accommodating said protuberance therein.

6. The fastening device of claim 5, wherein said protuberance extends along the longitudinal axis to terminate at two ends proximal to and distal from said abutting wall, respectively, said outer engaging section further having a first end flange which is connected with and is inclined relative to said end of said protuberance distal from said abutting wall, said annular groove extending along the longitudinal axis to terminate at two ends proximal to and distal from said friction wall, respectively, said inner engaging section further having a first slope surface which is connected with and is inclined relative to said end of said annular groove distal from said friction wall and which is retainingly engaged with said first end flange.

7. The fastening device of claim 5, wherein said protuberance extends along the longitudinal axis to terminate at two ends proximal to and distal from said abutting wall, respectively, said outer engaging section further having a second end flange which is connected with and is inclined relative to said end of said protuberance proximal to said abutting wall, said annular groove extending along the longitudinal axis to terminate at two ends proximal to and distal from said friction wall, respectively, said inner engaging section further having a second slope surface which is connected with and is inclined relative to said end of said annular groove proximal to said friction wall and which is retainingly engaged with said second end flange.

8. The fastening device of claim 1, wherein said fastening unit is in form of a nut, and said first threaded hole extends through said abutting portion and said tightening portion.

9. The fastening device of claim 8, wherein said tightening portion has a cylindrical wall extending along the longitudinal axis to terminate at an end which is connected with said abutting portion, and an opposite end which is connected with said abutting wall.

10. The fastening device of claim 1, wherein said fastening unit is in form of a bolt, said first threaded hole extends through said abutting portion, and said tightening portion is a threaded shaft which is threadedly engaged with said first threaded hole and said second threaded hole.

11. The fastening device of claim 3, wherein said reinforcing unit further has an elastic ring which is sleeved on said sleeve portion to seal a clearance between said sleeve portion and said extending portion.

12. The fastening device of claim 1, wherein said fastening unit further has a sleeve portion which is coaxially connected with said tightening portion, said reinforcing unit further having an extending portion which is connected with said friction wall and which extends along the longitudinal axis to be inserted into said sleeve portion.
